(19) United States
(12) Patent Application Publication
(10) Pub. No.: US 2012/0331137 A1
(43) Pub. Date: Dec. 27, 2012

(54) METHOD AND APPARATUS FOR ESTIMATING USER CHARACTERISTICS BASED ON USER INTERACTION DATA

(75) Inventors: Jesper Olsen, Beijing (CN); Jilei Tian, Beijing (CN)

(73) Assignee: NOKIA CORPORATION, Espoo (FI)

(21) Appl. No.: 13/582,232

(22) PCT Filed: Mar. 1, 2010
(86) PCT No.: PCT/CN10/70810

§ 371 Date: Aug. 31, 2012

(51) Int. Cl. G06F 15/173

(52) U.S. Cl. 709/224

(57) ABSTRACT

An approach is provided for estimating user characteristics based on user interaction data. A characteristics determination logic retrieves an interaction data from a device associated with a use. Next, the characteristics determination logic determines a usage vector from the interaction data. Then, the characteristics determination logic correlates the determined usage vector with one or more predefined characteristics. Then, the characteristics determination logic computes a user characteristics profile based, at least in part, on the one or more correlated characteristics.

### BACKGROUND

Service providers (e.g., wireless, cellular, etc.) and device manufacturers are continually challenged to deliver value and convenience to consumers by, for example, providing compelling network services. One area of development has been use of data mining as a tool to extract patterns in collected data. When a large amount of data is gathered, this can be analyzed to derive useful information. Often, more data points translate to greater accuracy of the derived information. Because people continually rely on their mobile devices, such as mobile phones, for various tasks such as communications, media playback, Internet browsing, and etc., data regarding usage of these mobile devices may be data mined. However, little effort has been provided in deriving useful information from such usage data. Therefore, there is a need to derive meaningful information from usage of mobile devices.

### SOME EXAMPLE EMBODIMENTS

Therefore, there is a need for an approach for estimating user characteristics based on user interaction data.

According to one embodiment, a method comprises retrieving an interaction data from a device associated with a user. The method also comprises determining a usage vector from the interaction data. The method further comprises correlating the determined usage vector with one or more characteristics. The method further comprises computing a user characteristics profile based, at least in part, on the one or more correlated characteristics.

According to another embodiment, an apparatus comprising at least one processor, and at least one memory including computer program code, the at least one memory and the computer program code configured to, with the at least one processor, cause, at least in part, the apparatus to retrieve an interaction data from a device associated with a user. The apparatus is also caused to determine a usage vector from the interaction data. The apparatus is further caused to correlate the determined usage vector with one or more characteristics. The apparatus is further caused to compute a user characteristics profile based, at least in part, on the one or more correlated characteristics.

According to another embodiment, a computer-readable storage medium carrying one or more sequences of one or more instructions which, when executed by one or more processors, cause, at least in part, an apparatus to retrieve an interaction data from a device associated with a user. The apparatus is also caused to determine a usage vector from the interaction data. The apparatus is further caused to correlate the determined usage vector with one or more characteristics. The apparatus is further caused to compute a user characteristics profile based, at least in part, on the one or more correlated characteristics.

According to another embodiment, an apparatus comprises means for retrieving an interaction data from a device associated with a user. The apparatus also comprises means for determining a usage vector from the interaction data. The apparatus further comprises means for correlating the determined usage vector with one or more characteristics. The apparatus further comprises means for computing a user characteristics profile based, at least in part, on the one or more correlated characteristics.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of estimating user characteristics based on user interaction data, according to one embodiment;

FIG. 2 is a diagram of the components of a characteristics determination logic, according to one embodiment;

FIG. 3 is a flowchart of a process for estimating user characteristics based on user interaction data, according to one embodiment;

FIG. 4 is a flowchart of a process for associating initial characteristics with interaction training data, according to one embodiment;

FIG. 5 is a flowchart of a process for supplementing interaction data with sampled communication information, according to one embodiment;

FIGS. 6A-6B are diagrams of the processes of FIG. 3, according to various embodiments;

FIGS. 7A-7B are diagrams of user interfaces utilized in the processes of FIG. 3, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for estimating user characteristics based on user interaction data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

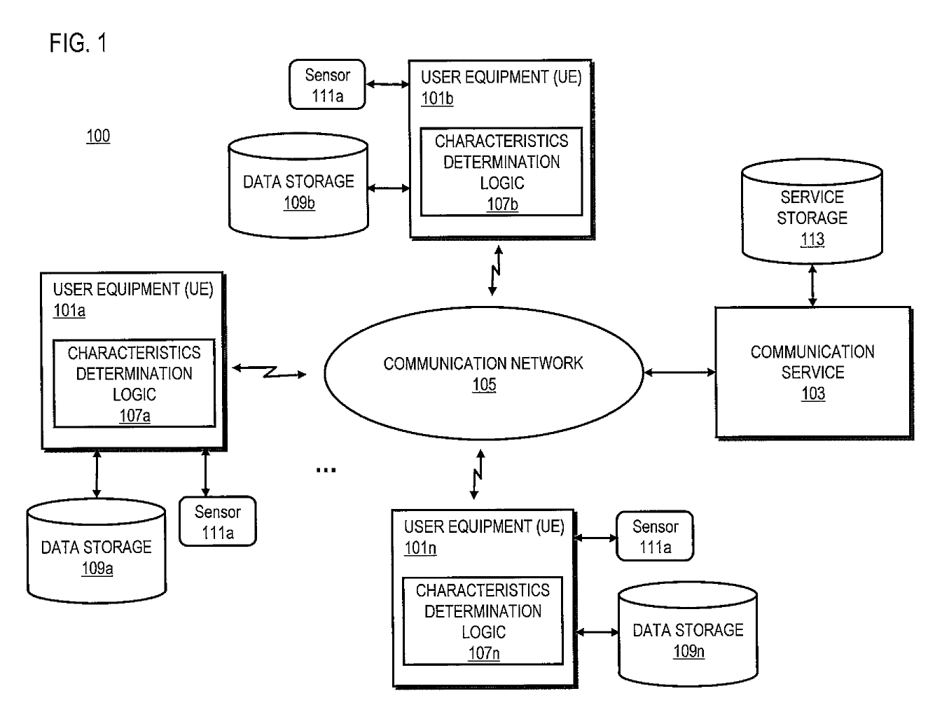

FIG. 1 is a diagram of a system capable of estimating user characteristics based on user interaction data, according to one embodiment. Characteristics of a person affect various aspects on the person's life style and decisions regarding personal and business situations. Therefore, understanding of the characteristics of the person may be useful in that the person's preferences and/or behavior may be estimated based on the personalities or other traits, and thus may be used to facilitate certain tasks and/or enhance the person's lives. For example, analysis of human personality has been used in career counselling, match-making, marriage counselling, marketing of certain products, and etc. Thus, human personalities have been under investigation for many decades, at least for these reasons. As a result, a human personality can be generally categorized into multiple personality elements representing different aspects of the personality. These personality elements may be determined by compiling and analyzing responses to questionnaires related to the personality elements. However, it is time consuming to respond to the set of questionnaires because the number of questions in the set is generally high in order to obtain more accurate results. Thus, although a person's personality may change over time, it is difficult to constantly update the person's personality elements.

It is noted that a record or profile of a user's tendencies or preferences can be readily maintained with a user device. For example, a history of websites visited by a specific user may be stored. Further, mobile devices are able to capture and store various information such as location information, often aided by Global Positioning System (GPS), a communication history including contact names and time of communication, and etc. In addition, these mobile devices can execute various sophisticated tasks including communicating with other devices using voice or data services, media playback and media capture, GPS navigation, and interne browsing. Mobile devices may also be configured with sensors to collect data about the surrounding environment—e.g., temperature, motion, etc. It is thus recognized that such mobile devices can acquire many different kinds of information that can exhibit a behavior or tendency of the user of the mobile device. Furthermore, as users are more immersed with usage of mobile devices, the user's use of mobile devices may be a good indicator to show the user's characteristics. Because different people use devices differently and frequently, the mobile devices and their usage can reflect people's behaviors and patterns. However, traditionally, there has not been exploitation of this useful information.

To address this problem, a system 100 of FIG. 1 introduces the capability to estimate user's characteristics based on the interaction data retrieved from a device associated with the user. The interaction data can be any input, activity, or event involving the user with respect to the functions and applications of the mobile device, and may be recorded with respect to context involving the device, such as time, location, environmental condition, and etc. In more detail, the system 100 enables the UEs 101a-101n (also collectively referred to as UE 101) to form a usage vector having vector parameters from the interaction data, and to correlate the usage vector with predefined characteristics. The system 100 may utilize a statistical classifier to correlate the usage vector with the predefined characteristics, after training the statistical classifier with interaction training data and other data from various users. With the correlated usage vector, the system 100 computes a user characteristic profile. The user characteristic profile may be constantly updated as more recent interaction data are collected.

Hence, an advantage of this approach, according to certain embodiments, is that a user characteristic profile can be automatically computed, whereas a conventional approach may require a user to respond to a set of questionnaires used to estimate the user's characteristics. Further, another advantage of this approach is that the user's characteristic profile may be automatically updated based on the most recent interaction data, and thus providing up-to-date information about the user's characteristics. Hence, the user does not have to spend time answering questionnaires to obtain the most up-to-date information about the user's characteristics. In addition, unlike the conventional approach, the user is not aware of when the interaction data is gathered, and thus more natural assessment of the user characteristics may be obtained. As a result, this approach saves the user's time and efforts in estimating the user's characteristics, and thus provides an efficient and accurate alternative to estimate the user's characteristics. Therefore, means for estimating the user characteristics based on the interaction data is anticipated.

As shown in FIG. 1, the system 100 comprises a user equipment (UE) 101 having connectivity to the communication service 103 via a communication network 105. By way of example, the communication network 105 of the system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.).

The UE 101 may also be connected to a sensor 111. The sensor 111 may be used to collect information, which may be stored in the data storage 109 or be used by the UE 101. In one embodiment, the sensor 111 may include a sound recorder, light sensor, global positioning system (GPS) device, temperature sensor, motion sensor, accelerometer, and/or any other device that can be used to collect information about surrounding environments associated with the UE 101.

The UE 101 may include a characteristics determination logic 107. In one embodiment, the characteristics determination logic 107 is capable of handling various operations and computations related to communication using the UE 101. For example, the characteristics determination logic 107 may manage incoming or outgoing communications via the UE 101, and display such communication. Further, the characteristics determination logic 107 computes a user characteristic profile based on the information provided to the UE 101 and predefined characteristics. The characteristics determination logic 107 may also provide visualization (e.g. graphical user interface) to allow a user to control communication over the communication network 105 and also to control other tasks such as computing the predefined characteristics. Further, the characteristics determination logic 107 may include interfaces (e.g., application programming interfaces (APIs)) that enable the user to communicate with Internet-based websites or to use various communications services (e.g., e-mail, instant messaging, text messaging, etc.) via the communication service 103. In some embodiments, the characteristics determination logic 107 may include a user interface (e.g., graphical user interface, audio based user interface, etc.) to access Internet-based communication services, initiate communication sessions, select forms of communications, and/or other related functions.

The communication service 103 provides various services related to communication to the UEs 101a-101n, such that the UEs 101a-101n can communicate with each other over the communication network. The services provided by the communication service 103 may include a cellular phone service, internet service, data transfer service, etc. In one embodiment, the communication service 103 may also provide media content such as music, videos, television services, etc, as well as applications or data base used to determine and update information on a person's characteristics based on acquired information. The communication service 103 may be connected to a service storage medium 113 to store or access data, such as data used to determine and update the person's characteristics. In yet another embodiment, the communication service 103 is also able to perform various computations to support the functions of the characteristics determination logic 107, some of which may be performed for the UE 101. For example, the communication service 103 can compute a user characteristic profile based on the information provided to the UE 101 and predefined characteristics.

By way of example, the UE 101 and the communication service 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

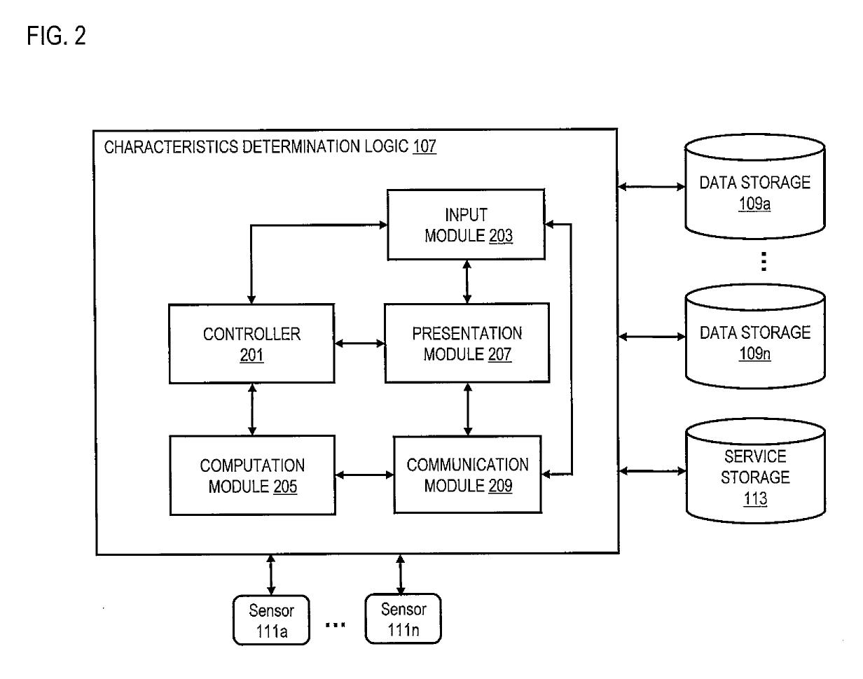

FIG. 2 is a diagram of the components of the characteristics determination logic 107, according to one embodiment. By way of example, the characteristics determination logic 107 includes one or more components for estimating user characteristics based on user interaction data. It is contemplated that the functions of these components may be combined in one or more components or performed by other components of equivalent functionality. In this embodiment, the characteristics determination logic 107 includes a control module 201, an input module 203, a computation module 205, a presentation module 207 and a communication module 209. The control module 201 oversees tasks, including tasks performed by the input module 203, the computation module 205, the presentation module 207 and the communication module 209. The computation module 205 performs computations and estimations that are used to complete a user characteristic profile. For example, the computation module 205 takes the acquired interaction data related to the user's interaction and behavior, and then estimates user's characteristics based on the acquired data and the predefined characteristics. By way of example, the computation module 205 determines a usage vector form the interaction data, and correlates the usage vector with predefined characteristics, such as Myers-Briggs type indicator (MBTI) dichotomies. Then, the computation module 205 a user characteristic profile based on the correlated characteristics. The computation module 205 may also determine recommended services, applications, media, documents, content and products based on the user characteristics profile. Furthermore, the computation module 205 may be used to train a statistical model for computing the user characteristics profile. Thus, the computation module 205 may identify multiple users according to predefined characteristics based on baseline data collected from the multiple users, and determine reference usage vectors associated with the users, based on the baseline data. Then, the computation module 205 may associate the predefined characteristics with the reference usage vectors.

The input module 203 manages and communicates an input into the UE 101, and also communicates information acquired by the sensors 111a-111n. The input into the UE 101 may be in various forms including pressing a button on the UE 101, touching a touch screen, scrolling through a dial or a pad, etc. The information acquired by the sensor 111a-111n may be in various types of data form or an electrical signal that is converted into a data form by the input module 203. Some of the information handled by the input module 203 may be used as the interaction data. Further, the input module 203 may collect samples of communications associated with the user of the UE 101, such that a recognition analysis may be performed to supplement the interaction data. The communication module 209 manages incoming and outgoing communications and may control storing the communication history in the data storage medium 109 or the service storage medium 113. The communication module 209 may also collect information regarding communicating parties, forms of communication, communication time, and any other information related to the communication, such that this information may be used as the interaction data. The presentation module 207 controls display of a user interface such as graphical user interface, to convey information and to allow user to interact with the UE 101 via the interface. Further, the presentation module 207 interacts with the control module 201, the input module 203 and the communication module 209 to display any necessary information that needs to be conveyed, such as the user characteristic profile, interaction history log, and details on the predefined characteristics.

The UE 101 may also be connected to storage media such as the data storage media 109a-109n such that the characteristics determination logic 107 can access data or store data in the data storage media 109a-109n. If the data storage media 109a-109n are not local, then they may be accessed via the communication network 105. The UE 101 may also be connected to the service storage medium 113 via the communication network 105 such that the characteristics determination logic 107 may be able to control the data in the service storage medium 113 and store and access data in the service storage medium 113.

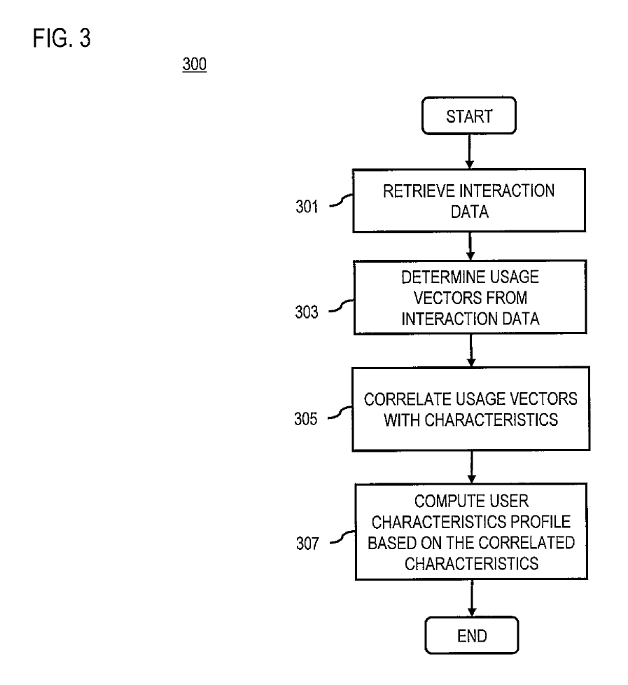

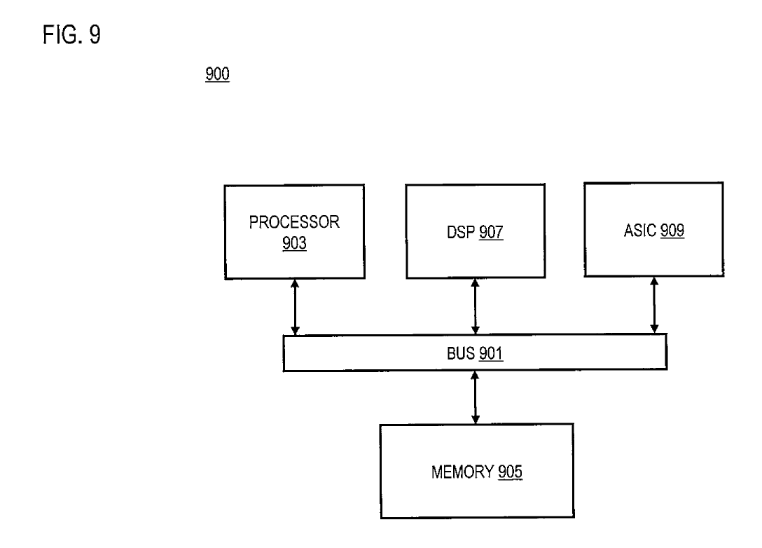

FIG. 3 is a flowchart of a process for estimating user characteristics based on user interaction data, according to one embodiment. In one embodiment, the characteristics determination logic 107 performs the process 300 and is implemented in, for instance, a chip set including a processor and a memory as shown FIG. 9. In step 301, the characteristics determination logic 107 retrieves the interaction data from a device associated with a user. Then, in step 303, usage vectors are determined from the interaction data. The interaction data may include multiple types of data, such as a composition of contact list, a communication history, a webpage history, calendar information, a location history and environment information, wherein different types of interaction data form corresponding usage vectors.

The composition of contact list may include information about the number of contacts, and information about each contact such as gender, age, etc. For example, a large number of contacts may indicate that the user is an extrovert. As another example, the number of females and the number of males in the contact list may indicate several characteristics of the user (e.g., if the user is male and has mostly females on the contact list, then this may be an indication that the user is a male who observes a lot of female characteristics). As another example, if the user's age is in the 40s, and most people on the contact list are in the 20s or younger, this may be an indication that the user may be young at heart, which may affect the user's characteristics. The communication history includes the number of telephone communications, the number of text messages or email messages, the duration of the telephone communication, the number of incoming communication and the number of outgoing communication. The frequency of use for different forms of communication (e.g. the number of text message communication and the number of phone communication) as well as a time of frequent communication (e.g. the numbers of communication during the day, in the morning and in the evening) may be analyzed to estimate the user's characteristics. Further, the number of communications may be sorted by categories such as friends, coworkers, family, etc. For example, a high number of communications within a set period of time may indicate that the user likes to spend a lot of time communicating, which indicates one aspect of the personality. The webpage history shows the webpages visited by the user and the frequency of the visits. The types of webpages visited by the user may vary depending on the user's characteristics, and thus the webpage history can be an indication of one aspect of the user's characteristics.

Further, the calendar information including the user's schedule may indicate the user's characteristics. For example, the calendar information may show that the user has a very busy social schedule, or the calendar information may show that the user's work schedule involves many meetings. Based on the type and frequency (or recurrence) of activities on the calendar, the user's characteristics may be estimated. Further, when coupled with a location detecting device such as a GPS device, the calendar information may also show whether the user is punctual when the calendar shows that the user needs to be at a certain location by a certain time. The location history may keep a record of the location of the user's mobile device, and thus, assuming that the user is within proximity of the user's mobile device, the location history keeps a record of the location of the user. The mobile device may rely on a GPS device, cell ID and/or WiFi based location detection to estimate the location of the mobile device. The location of the mobile device may be coupled with information related to the location (e.g. home, bars, restaurant, school, etc.). For example, one user's location history indicating that the user frequents bars and restaurants and another user's location history indicating that the user is usually at home may result in different indications for characteristics. The environment information may include a noise level, brightness, etc, and may retrieve such information from a sensor 111 that senses sound, brightness and etc. For example, a user who frequents loud places such as bars and noisy restaurants may have different characteristic traits than a user who frequents quiet places. Further, media use history (e.g. history of downloading, streaming, playing of different types of media) may also be used to estimate characteristics because users tend to prefer different types and genres of media depending on their characteristics. In addition, application use history may be used to estimate characteristics because users may use different types of applications depending on their characteristics. For example, some aspects of the user's characteristics may be estimated by examining what type of games the user routinely plays (e.g., action games, puzzle games, role-playing games and etc).

In step 305, the characteristics determination logic 107 correlates the usage vectors determined in step 303 with predefined characteristics. The characteristics may be predefined indicators of certain aspects of a user's personality. For example, Myers-Briggs type indicator (MBTI) may be used as predefined characteristics, by measuring how people perceive different situations and make decisions. The Myers-Briggs type indicator involves four pairs of dichotomies representing different aspects of characteristics, which are (1) Extraversion/Introversion, (2) Sensing/Intuition, (3) Thinking/Feeling and (4) Judging/Perceiving, wherein item (1) represents an attitude, items (2) and (3) represent psychological functions, and item (4) represents the lifestyle. Thus, these four pairs of dichotomies may be correlated with the usage vectors. The predefined characteristics may also be related to age, gender or family relationship. For example, age and gender may be estimated by examining the voice during communications. The family relationship may be estimated by examining a location history and a communication history, for example. If certain users spend every evening in the same location (e.g., a house), and spend the entire evening in the location (i.e., while sleeping), this may be an indication that these users may be family members. If these users travel together during holidays to the same locations, this would be an additional indication that these users may be family members. Furthermore, in step 305, the correlation between the usage vectors and the predefined characteristics may be based on an algorithm or a model such as a statistical classifier.

In one embodiment, the sensor data of user A and user B may define that user A and user B are family members. Based on this defined relationship, user A's device may receive, transmit, and/or exchange sensor data with user B's device. In one embodiment, the closeness of the relationship may be used to define what sensor data is exchanged. For example, if user A and user B have a close relationship (e.g., husband and wife) then more specific location data (e.g., accurate to a few meters) and/or more frequent data (e.g., every hour vs. every day) may be exchanged. In another example, if the relationship is not very close (e.g., user A and user B are merely members of the same social network), then no sensor data may be exchanged or specific prior approval to exchange the sensor data may be requested. When no additional sensor data is exchange, the characteristics determination logic 107 may nonetheless evaluate other available data (e.g., communication history, contact lists, etc.).

The sensor data from the user A's device and the sensor data from the user B's device can then be compared with each other in each user's respective device to determine, for instance, whether there is a sufficiently close match of the sensor data (e.g., location data in both devices states that the location has been similar enough or, during last year there has been activities where these two users have been in two or more places together more than a predefined time). In one embodiment, a sufficiently close match may result in changes to the user interfaces or software features in the devices of one or both of the users A and B. By way of example, user A's device can change or suggest changes to its interfaces or features (e.g. the phone book in the user A's device) so that data or information related to user B is more available, visible, or otherwise more easily accessible. For example, the changes in the device may (1) make a clickable widget on the screen to present user data; (2) change the order of the names in the phone book of the device; (3) add a field to the phone book to distinguish between work, family, hobby-related contacts and etc.; (4) add metadata to certain images the user might have in the user's device; (5) add metadata to map application so that when the user reviews a tracked route of his own, a combined route of the two users can be also found and indicated based on the identified similar data between the users; or other like changes.

In one embodiment, user A's device executes a computer program which handles the data based on a logic, a method, or a process developed for the analysis of the data. In addition or alternatively, the analysis of the data may be performed by a service provider or other external server, computer system, platform, module, a combination thereof; or the like. In this way, if user A's device has limited resources (e.g., limited memory, limited processing capabilities, etc.), then all or a portion of the analysis process can be shared with, for instance, the service provider or other external component. In one embodiment, this data analysis can be conducted in a services portal (e.g., Nokia's OVI services) where the data from user A and user B can be collected and the analysis can be done between the users.

Then, in step 307, the characteristics determination logic 107 computes a user characteristics profile based on the correlated characteristics. Additionally, although not shown in the flowchart, the user characteristics profile may be updated over a period time. For example, the interaction data may be monitored over a period of time, and the user characteristics profile may be updated based on the monitored interaction data. This is advantageous in that the characteristics determination logic 107 constantly updates the user characteristics profile based on the recent interaction data, and thus can provide accurate and most up-to-date version of the user characteristic profile. Further, the amount of acquired interaction data is more in the latter stage of the user characteristics profile computation than in the beginning stage, and thus it may be important to continue to update the user characteristic profile as more interaction data are acquired.

This process is advantageous in that it provides a method to determine various aspects of user characteristics based on interaction data gathered by the user's mobile device, as the user naturally uses the user's mobile device. Further, based on the interaction data, the user characteristics may be constantly updated. Thus, this process provides an easy way to determine user characteristics without consuming the user's time and efforts. The characteristics determination logic 107 is a means for achieving these advantages.

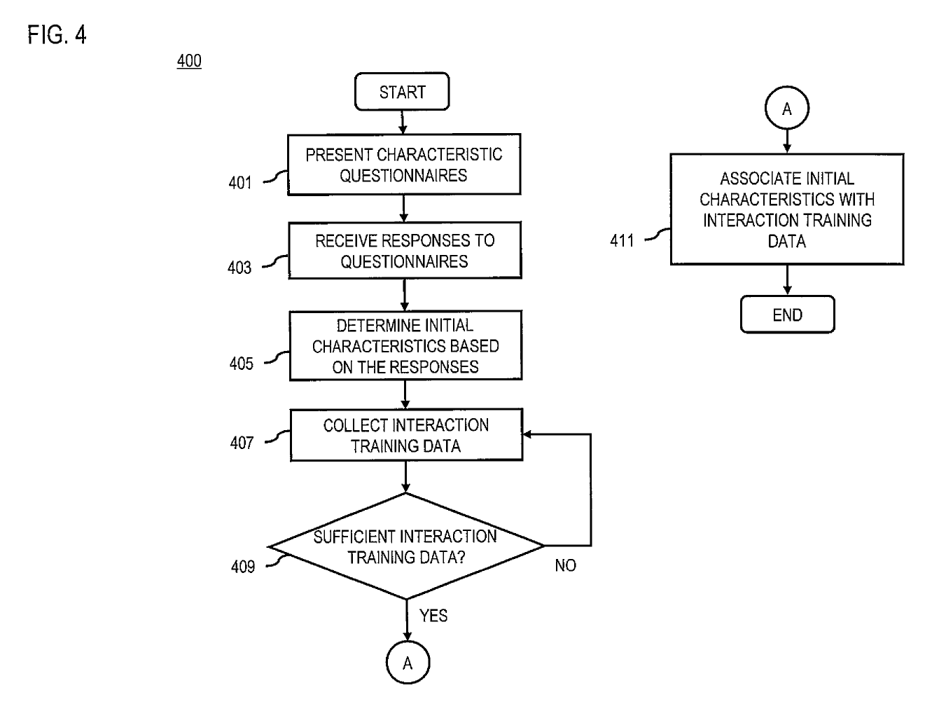

FIG. 4 is a flowchart of a process for associating initial characteristics with interaction training data, according to one embodiment. In one embodiment, the characteristics determination logic 107 performs the process 400 and is implemented in, for instance, a chip set including a processor and a memory as shown FIG. 9. In step 401, the characteristics determination logics 107a-107n of the UEs 101a-101n present characteristic questionnaires, as shown 401, to initially estimate characteristics of users of the UEs 101a-101n. The users may choose to participate in the questionnaires or refuse to participate. The communication service 103 may also be set to reward the users who participate in the questionnaires with virtual money, points, accessories and etc., to provide incentives for the users to participate. The questionnaires may be based on Myers-Briggs Type Indicator assessment questionnaires, for example. The user then may answer these questions such that the characteristics determination logic 107 receives the user's responses to the questionnaires, as shown in step 403. Then, the characteristics determination logic 107 determines initial characteristics based on the responses, as shown in step 405. Further, as shown in step 407, interaction training data is collected at each of the UEs 101a-101n. Here, the interaction training data and the initial characteristics form a baseline data used to initially estimate characteristics and train a statistical classifier such that the statistical classifier may later be used to estimate characteristics of a user based on interaction data, without presenting characteristic questionnaires. The interaction training data is interaction data that is collected to be used to train a statistical classifier, and is collected until sufficient interaction training data is acquired from a sufficient number of users, as shown in step 409. As a part of training the statistical classifier, initial characteristics are associated with interaction training data, as shown in step 411. This association may be performed by the characteristics determination logic 107 or the communication service 103. However, it may be more advantageous to perform step 411 in the communication service 103 because step 411 may handle a large amount of data from many different users and the communication service 103 may have a higher processing power than the characteristics determination logic 107.

This process is advantageous in that it trains the statistical classifier to help accurate determination of user characteristics. The characteristics determination logic 107 and/or the communication service 103 are means for achieving these advantages.

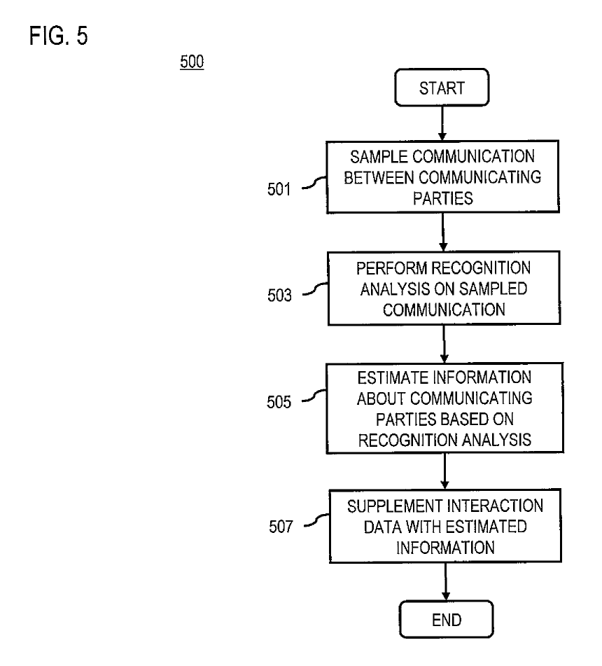

FIG. 5 is a flowchart of a process for supplementing interaction data with sampled communication information, according to one embodiment. In one embodiment, the characteristics determination logic 107 performs the process 500 and is implemented in, for instance, a chip set including a processor and a memory as shown FIG. 9. In step 501, the characteristics determination logic 107 takes a sample of communication between communicating parties. The sample may be an audio clip of communication between the communicating parties, and the duration of the sample needs to be long enough for recognition analysis to work properly on the sample. Then, in step 503, the characteristics determination logic 107 performs recognition analysis on the sampled communication. The recognition analysis may include voice recognition and pitch/sound recognition, which may be used to determine approximate age and gender. For example, a teenager sounds differently from an elderly person, and thus recognition analysis may be able to differentiate age groups. Further, woman's voice generally has a higher pitch than man's voice, which may be differentiated by the recognition analysis. Further, based on the recognition analysis, the characteristics determination logic 107 estimates information about the communicating parties, as shown in step 505. The information about the communicating parties may include identities of communicating parties, characteristics of the communicating parties and environmental characteristics in the communication. The recognition analysis may be able to distinguish among the people's voices on the contact list, and determine the identities of the communicating parties. Then, the interaction data is supplemented with the estimated information based on the recognition analysis, as shown in step 507.

Thus, this process of recognition analysis is advantageous in that it provides additional information for computation of the user characteristics profile, and thereby, enabling a more accurate determination of the user's behavior. The additional information may be used to supplement the information provided by the interaction data. The characteristics determination logic 107 is a means for achieving this advantage.

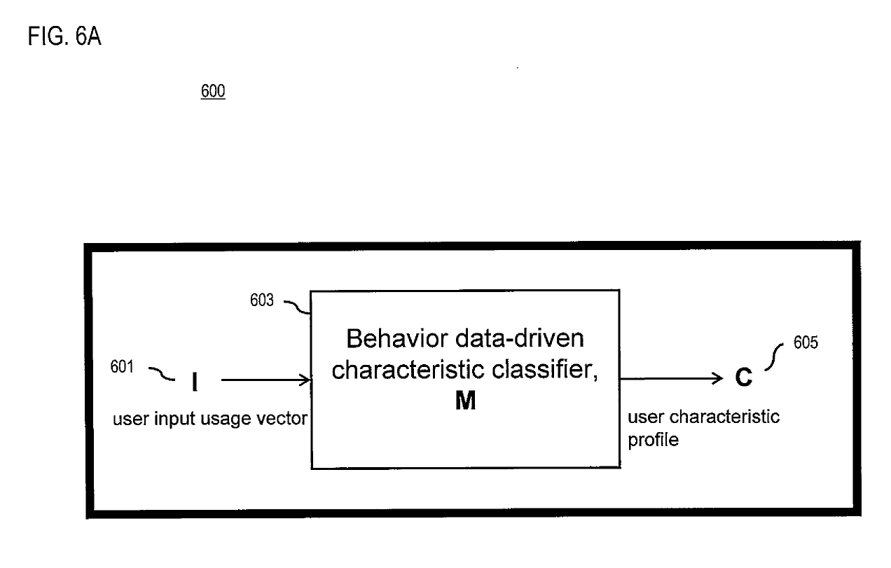

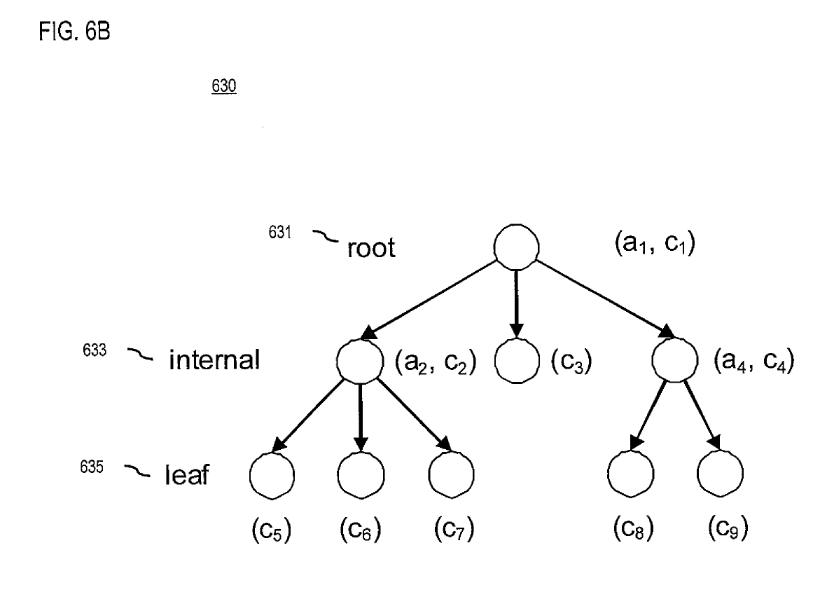

FIGS. 6A-6B are diagrams of computation of user characteristic profile in the processes of FIG. 3, according to various embodiments. FIG. 6A shows a block diagram of a process 600 to use an input usage vector to estimate a user characteristic profile. The input usage vector 601 shown as I includes information related to a plurality of interaction data discussed above. Thus, the input usage vector 601 may be denoted as I=(i₁, i₂, i₃, . . . , i_{N}), wherein i₁-i_{N} represent parameters for N types of interaction data. If the user's personality is determined, the user characteristic profile 605 shown as C may be coded as a combination of four dimensions defined as Extraversion/Introversion (E/I), Sensing/Intuition (S/I), Thinking/Feeling (T/F) and Judging/Perceiving (J/P). For example, the user having extraversion, sensing, thinking and judging as four characteristics may be denoted by the function C=(E, S, T, J). When the input usage vector 601 is determined based on the retrieved interaction data, the usage vector is used to compute the user characteristics profile based on the usage vector and the predefined characteristics using the statistical classifier 603 shown as M. The statistical classifier 603 may be a decision tree (DT), artificial neural network (ANN) or a support vector machine (SVM). The statistical classifier M 603 may include one or more classifiers. For example, the statistical classifier M 603 may include one classifier that is trained for all four dichotomies of Myers-Briggs assessment, or may include four classifiers that are each assigned to the four dichotomies such that each classifier handles one dichotomy. Further, the statistical classifier M 603 may be set such that the classification can be done either in a discrete fashion or as a probability measure. For example, in a discrete fashion, the attitude will be determined as either extroversion or introversion, whereas in a probability measure, the attitude may be determined in degrees, such as 80% extroversion or 20% introversion.

FIG. 6B shows a decision tree, which may be implemented for the statistical classifier M 603. Decision tree 630 is traversed down from the root node 631. At the root node, in this example, the tree starts with the attribute a₁ and characteristic c₁. During this traversal, the decision tree moves towards a branch with the attribute value matching with information represented by the branch. The tree is traversed downwards until a leaf node 635 is found, or there is no matching attribute value in the tree. The internal node 633 in this example has only one internal node, but may also include multiple levels of the internal node. In the leaf node 633, the characteristic values c₃-c₉ may represent Myers-Briggs Type Indicator assessment dichotomies, for example. In the decision tree implementation, the statistical classifier M 603 can be designed to give discrete output (e.g. either Extroversion or Introversion), or alternatively with a support vector machine or Hidden Markov model, an implementation of probability measure output (e.g. 80% Extroversion and 20% Introversion) can be computed.

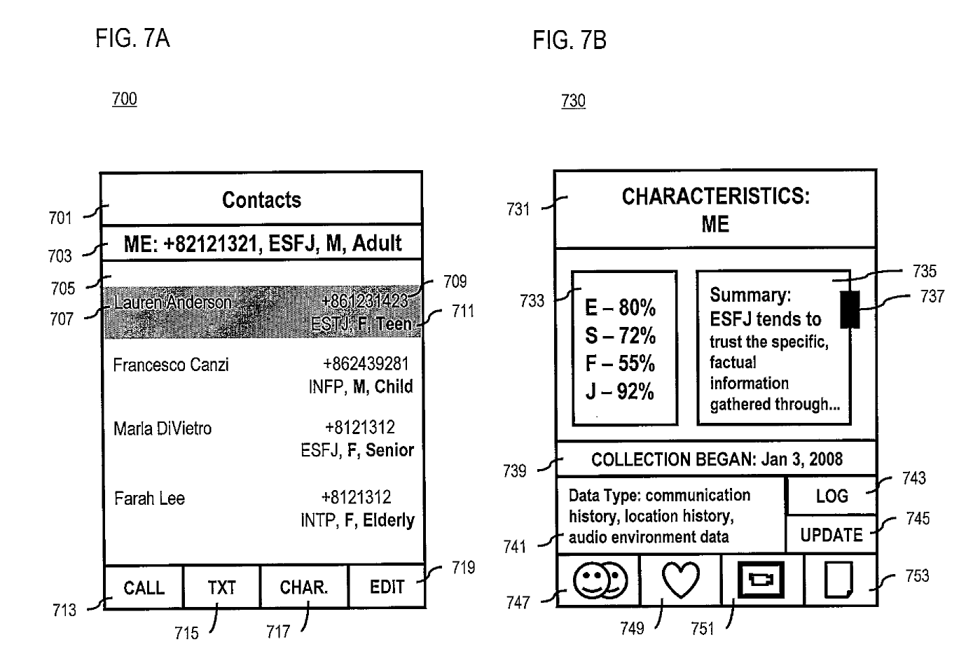

FIGS. 7A-7B are diagrams of user interfaces utilized in the processes of FIG. 3, according to various embodiments. FIG. 7A is a contact list user interface 700 showing a contact list, according to one embodiment. The information panel 701 shows that the user interface 700 is showing a contact list. The user panel 703 shows the information related to the user of the device, such as the user's name, the user's telephone number, the personality, the gender and the age group. The contact list 705 has a list of people that the user can contact. For each contact, a name of the person 707, the person's phone number 709, and a brief characteristic profile 711 is shown. The brief characteristic profile 711 shows the Myers-Briggs type indicator, gender (e.g. M for male and F for female), and age group (e.g. child, teen, adult, senior, elderly). The user may move the highlighted bar up and down to select a person to contact. In this case, the highlighted bar is on “Lauren Anderson.” The call option 713 or the text option 715 may be selected to allow the user to make a phone call or send a text message to the selected person. The characteristic option 717 may be selected to view details about the selected person's characteristic profile. The user panel 703 may also be selected to view details about the user's characteristic profile. The edit option 719 allows the user to change contact information of the selected person.

FIG. 7B is a characteristic profile user interface 730 showing details about a characteristic profile, according to one embodiment. The characteristic profile user interface 730 may be activated when the characteristic option 717 in FIG. 7A is selected. The information panel 731 shows that the user interface is showing the characteristic profile of the user (i.e. ME). The Myers-Briggs panel 733 shows the four dichotomies and the degrees for each dichotomy. In this case, the user has 80% extroversion (E), and thus has 20% introversion. The user also has 72% sensing (S), 55% feeling (F) and 92% judging (J), and thus has 28% intuition (I), 45% thinking (T) and 8% perceiving (P). The summary panel 735 having a scroll bar 637 to navigate up and down on the summary panel 735 displays a summary of the characteristics of the user. Further, a time regarding collection of the interaction data can be shown in the data collection panel 739, which shows that the interaction data has been collected since Jan. 3, 2008, in this example. The data type panel 741 shows the types of interaction data considered in computation of the characteristics. The examples of types of interaction data have been discussed previously. The log option 743 shows a detailed log of interaction data collected with respect to time. The update option 745 allows updating the characteristics by considering the interaction data that are collected until recently. On the bottom of the character profile user interface 730, recommendations based on the characteristics are available. The friend option 747 suggests possible users who can be friends based on the characteristics, and the date option 749 suggests possible dates for the user of the UE 101 based on the characteristics of the user. The media option 751 suggests media based on the characteristics of the user. Additional options for recommendations may be selected in a separate user interface (not shown), wherein the additional options may include recommendations on applications, documents, products, contents, etc. The job option 753 suggests jobs based on the characteristics of the user.

The processes described herein for estimating user characteristics based on user interaction data may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

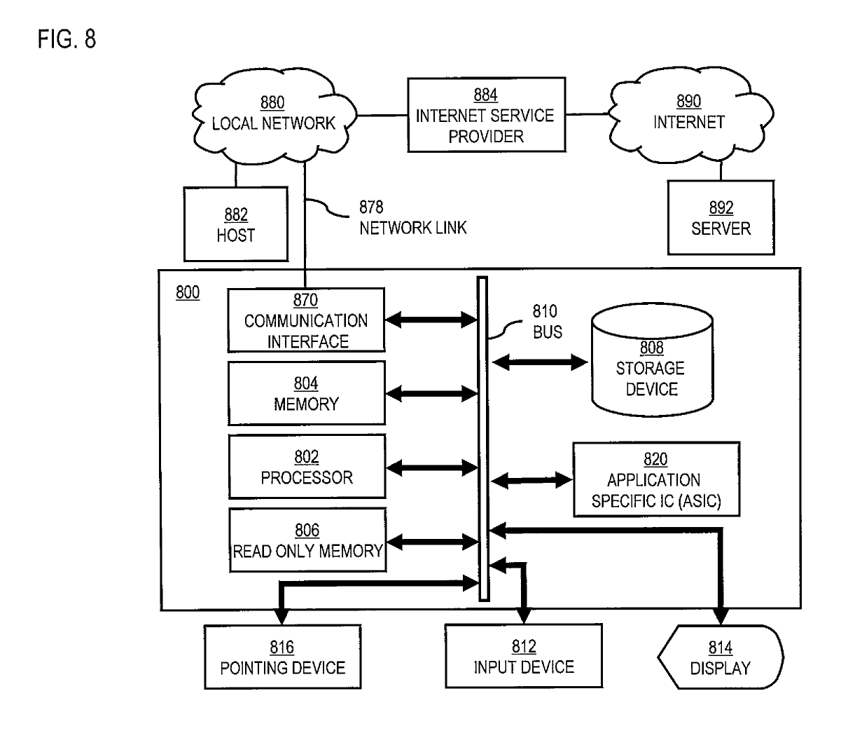

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to estimate user characteristics based on user interaction data as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of estimating user characteristics based on user interaction data.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to estimating user characteristics based on user interaction data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for estimating user characteristics based on user interaction data. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for estimating user characteristics based on user interaction data, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for estimating user characteristics based on user interaction data.

The term “computer-readable medium” as used herein to refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set 900 upon which an embodiment of the invention may be implemented. Chip set 900 is programmed to estimate user characteristics based on user interaction data as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of estimating user characteristics based on user interaction data.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to estimate user characteristics based on user interaction data. The memory 905 also stores the data associated with or generated by the execution of the inventive steps.

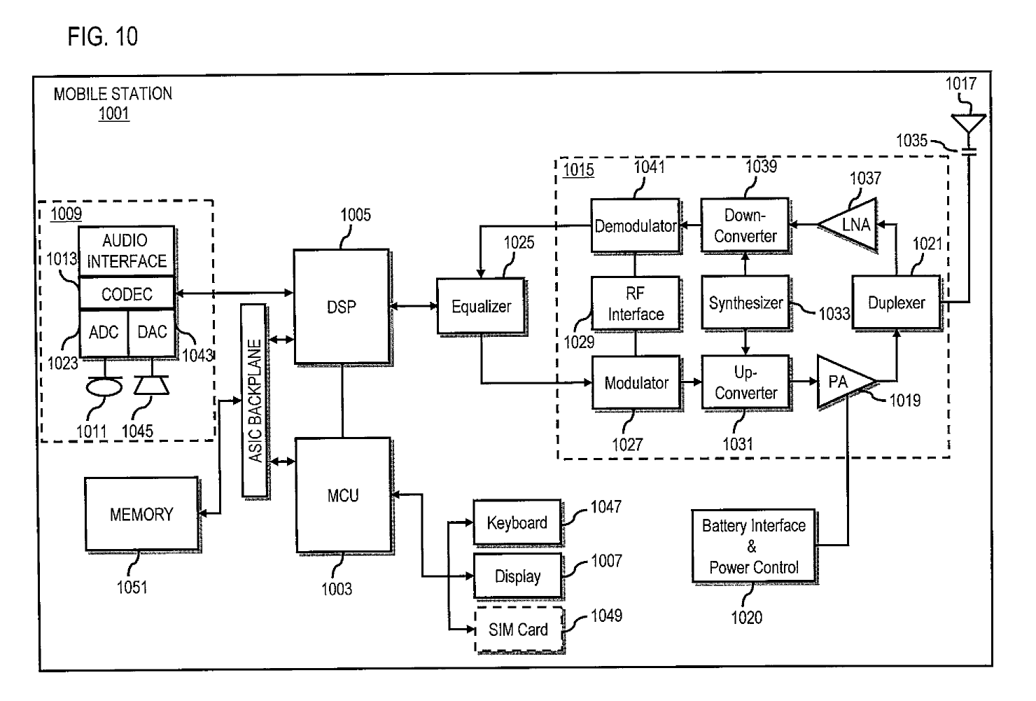

FIG. 10 is a diagram of exemplary components of a mobile terminal (e.g., handset) for communications, which is capable of operating in the system of FIG. 1, according to one embodiment. In some embodiments, mobile terminal 1000, or a portion thereof, constitutes a means for performing one or more steps of estimating user characteristics based on user interaction data. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of estimating user characteristics based on user interaction data. The display 10 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (CPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to estimate user characteristics based on user interaction data. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-38. (canceled)

39. A method comprising:
retrieving an interaction data from a device associated with a user;
determining a usage vector from the interaction data;
correlating the determined usage vector with one or more predefined characteristics; and
computing a user characteristics profile based, at least in part, on the one or more correlated characteristics.

40. A method of claim 39, further comprising:
causing, at least in part, sampling of one or more communications associated with the user;
performing recognition analysis on the sampled one or more communications; and
supplementing the interaction data with results of the recognition analysis.

41. A method of claim 40, further comprising:
determining communicating parties, characteristics of the communicating parties, environmental characteristics, or a combination thereof based on the recognition analysis,
wherein the supplementing of the interaction data includes the determined communicating parties, characteristics of the communicating parties, environmental characteristics, or a combination thereof.

42. A method of claim 39, further comprising:
determining recommended services, applications, media, documents, content, products, or a combination thereof based on the user characteristics profile; and
causing, at least in part, presentation of the determined recommendations.

43. A method of claim 39, further comprising:
monitoring the interaction data over a period time,
wherein the user characteristics profile is updated based on the monitored interaction data.

44. A method of claim 39, further comprising:
collecting a baseline data set from a plurality of other users;
identifying each of the other users according to the one or more predefined characteristics based, at least in part, on the baseline data set;
determining a reference usage vector associated each of the other users based, at least in part, on the baseline data set; and
associating each of the predefined characteristics with a respective one of the reference usage vectors,
wherein the correlating of the determined usage vector with the one or more predefined characteristics is based, at least in part, on the association of the respective reference usage vector with the respective characteristic.

45. A method of claim 39, wherein the user profile is a personality profile and the predefined characteristics include, at least in part, an extraversion/introversion dichotomy, a sensing/intuition dichotomy, a thinking/feeling dichotomy, judging/perceiving dichotomy, or a combination thereof.

46. A method of claim 39, wherein the user profile is a family profile and the predefined characteristics include, at least in part, age, gender, familial relationship, or a combination thereof.

47. A method of claim 39, wherein the interaction data includes contact list information, communication history, web browsing history, calendar information, movement history, audio environment data, application use history, media use history, or a combination thereof.

48. An apparatus comprising:
at least one processor; and
at least one memory including computer program code,
the at least one memory and the computer program code configured to, with the at least one processor, cause the apparatus to perform at least the following,
retrieve an interaction data from a device associated with a user;
determine a usage vector from the interaction data;
correlate the determined usage vector with one or more predefined characteristics; and
compute a user characteristics profile based, at least in part, on the one or more correlated characteristics.

49. An apparatus of claim 48, wherein the apparatus is further caused, at least in part, to:
cause, at least in part, sampling of one or more communications associated with the user;
perform recognition analysis on the sampled one or more communications; and
supplement the interaction data with results of the recognition analysis.

50. An apparatus of claim 48, wherein the apparatus is further caused, at least in part, to:
determine communicating parties, characteristics of the communicating parties, environmental characteristics, or a combination thereof based on the recognition analysis,
wherein the supplementing of the interaction data includes the determined communicating parties, characteristics of the communicating parties, environmental characteristics, or a combination thereof.

51. An apparatus of claim 48, wherein the apparatus is further caused, at least in part, to:
determine recommended services, applications, media, documents, content, products, or a combination thereof based on the user characteristics profile; and
cause, at least in part, presentation of the determined recommendations.

52. An apparatus of claim 48, wherein the apparatus is further caused, at least in part, to:
monitor the interaction data over a period time,
wherein the user characteristics profile is updated based on the monitored interaction data.

53. An apparatus of claim 48, wherein the apparatus is further caused, at least in part, to:
collect a baseline data set from a plurality of other users;
identify each of the other users according to the one or more predefined characteristics based, at least in part, on the baseline data set;
determine a reference usage vector associated each of the other users based, at least in part, on the baseline data set; and
associate each of the predefined characteristics with a respective one of the reference usage vectors,
wherein the correlating of the determined usage vector with the one or more predefined characteristics is based, at least in part, on the association of the respective reference usage vector with the respective characteristic.

54. An apparatus of claim 48, wherein the user profile is a personality profile and the predefined characteristics include, at least in part, an extraversion/introversion dichotomy, a sensing/intuition dichotomy, a thinking/feeling dichotomy, judging/perceiving dichotomy, or a combination thereof.

55. An apparatus of claim 48, wherein the user profile is a family profile and the predefined characteristics include, at least in part, age, gender, familial relationship, or a combination thereof.

56. An apparatus of claim 48, wherein the interaction data includes contact list information, communication history, web browsing history, calendar information, movement history, audio environment data, application use history, media use history, or a combination thereof.

57. An apparatus of claim 48, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

58. A computer program product including one or more sequences of one or more instructions which, when executed by one or more processors, cause an apparatus to at least perform the steps of:
retrieving an interaction data from a device associated with a user;
determining a usage vector from the interaction data;
correlating the determined usage vector with one or more predefined characteristics; and
computing a user characteristics profile based, at least in part, on the one or more correlated characteristics.
